(19) United States
(12) Patent Application Publication
(10) Pub. No.: US 2008/0263191 A1
(43) Pub. Date: Oct. 23, 2008

(54) METHOD AND SYSTEM FOR HANDLING PACKET FILTERING INFORMATION

(76) Inventors: Hemal Shah, Trabuco Canyon, CA (US); Protip Roy, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/105,617

(22) Filed: Apr. 18, 2008

Related U.S. Application Data
(60) Provisional application No. 60/912,885, filed on Apr. 19, 2007.

(51) Int. Cl. G06F 15/173

(52) U.S. Cl. 709/223

(57) ABSTRACT

A portion of management traffic, carried via network traffic, and received and/or transmitted via a network controller, may be processed externally to the network controller, wherein management messaging may be carried via network packets, and one or more headers may added to enable transmission and/or reception via the network controller. Packet filters may be setup, in the network controller, via the management controller, to enable determining network packets that may carry the management traffic. The management controller may utilize commands to setup packet filers in the network controller, wherein matching criteria, in received network packets, and/or corresponding actions that may be performed in matching packets, may be specified. The matching criteria may comprise specifying one or more header types that may be utilized in the received network packets. The network controller may generate filter identifiers, which may be utilized, subsequently, via the management controller to delete the packet filters.

### CROSS-REFERENCE TO RELATED APPLICATIONS/INCORPORATION BY REFERENCE

This patent application makes reference to, claims priority to and claims benefit from U.S. Provisional Application Ser. No. 60/912885 (Attorney Docket No. 18398US01) filed on Apr. 19, 2007.

The above stated application is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to network management. More specifically, certain embodiments of the invention relate to a method and system for handling packet filtering information.

### BACKGROUND OF THE INVENTION

Information Technology (IT) management may require performing remote management operations of remote systems to perform inventory and/or to determine whether remote systems are up-to-date. For example, management devices and/or consoles may perform such operations as discovering and/or navigating management resources in a network, manipulating and/or administrating management resources, requesting and/or controlling subscribing and/or unsubscribing operations, and executing and/or specific management methods and/or procedures. Management devices and/or consoles may communicate with devices in a network to ensure availability of remote systems, to validate that systems may be up-to-date, and/or to perform any security patch updates that may be necessary.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for handling packet filtering information, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary communication setup between a management device and a network device, which may be utilized in accordance with an embodiment of the invention.

FIG. 2A is a block diagram that illustrates an exemplary system that comprises a network controller and a management controller, which may be utilized to enable packet filtering of management traffic, in accordance with an embodiment of the invention.

FIG. 2B is a block diagram illustrating an exemplary protocol stack diagram for management-based application data carried via network traffic, in accordance with an embodiment of the invention.

FIG. 2C is a block diagram illustrating an exemplary structure of a command that may be utilized to set packet filters in a network controller, in accordance with an embodiment of the invention.

FIG. 2D is a block diagram illustrating an exemplary structure of a command that may be utilized to delete packet filters in a network controller, in accordance with an embodiment of the invention.

FIG. 3 is a flow diagram that illustrates exemplary messaging during packet filtering setup in a system, in accordance with an embodiment of the invention.

### DETAILED DESCRIPTION OF THE INVENTION

Certain embodiments of the invention may be found in a method and system for handling packet filtering information. In a device that may participate in network management operations, a portion of management traffic, carried via network traffic, and received and/or transmitted via a network controller, may be processed externally to the network controller. Management based messaging may be transmitted and/or received via the device and may be carried via network packets, wherein management data may be encapsulated and one or more headers may be added to enable transmission and/or reception via the network controller. Packet filters may be setup, in the network controller to enable determining network packets that may carry the management traffic. The packet filters may be setup in the network controller via a management controller. The management controller may utilize commands to setup packet filers in the network controller, such that the set filter commands may specify matching criteria, in received network packets, and/or corresponding actions that may be performed in matching packets. The matching criteria may comprise specifying one or more header types, which may be integrated into the received network packets. The network controller may communicate back to the management controller 204 filter identifiers that may be utilized, subsequently, to delete the packet filter.

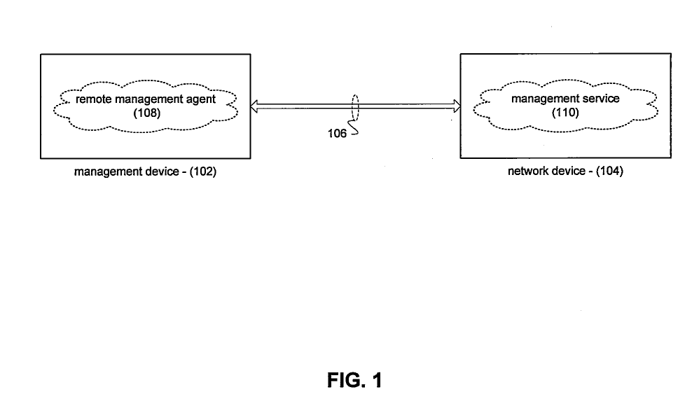

FIG. 1 is a block diagram that illustrates an exemplary communication setup between a management device and a network device, which may be utilized in accordance with an embodiment of the invention. Referring to FIG. 1, there is shown a management device 102, a network device 104, a management connection 106, a remote management agent 108, and a management service 110.

The management device 102 may comprise suitable logic, circuitry, and/or code that may enable management of network devices, for example the network device 104, via a management connection, for example the management connection 106. For example, the management device 102 may be utilized by Information Technology (IT) operators to enable management of various devices in an IT network. The management device 102 may also comprise a dedicated entity, for example the remote management agent 108, to enable performing management operations, which may comprise discovering and/or navigating management resources in a network, manipulating and/or administering management resources, requesting and/or controlling subscribing and/or unsubscribing operations, and executing and/or specific management methods and/or procedures.

The remote management agent 108 may comprise suitable logic, circuitry, and/or code that may enable performing management operations based on one or more management standards. For example, the remote management agent 108 may enable performing control and/or management operations, based on Web Service Management (WS-Management) and/or Alert Standard Format (ASF) protocols, of existing and/or known nodes, which support similar protocols, in a network. The remote management agent 108 may comprise a logical and/or software entity that may be integrated within an OS running in the management device 102. The remote management agent 108 may comprise a logical and/or software entity that may be integrated within a general network controller (NIC) which may be running in the management device 102. The remote management agent 108 may comprise a logical and/or software entity that may be integrated within a network controlled running within a dedicated management sub-system within the management device 102. The management device 102 may perform management operations, via the remote management agent 108, for example, the management device 102 may communicate with devices in a network to ensure availability of remote systems, to validate that systems may be up-to-date, and/or to perform any security patch updates that may be necessary.

The network device 104 may comprise suitable logic, circuitry, and/or code that may enable management by one or more management devices, for example the management device 102, via a management connection, for example the management connection 106. The network device 104 may be integrated into a network that may be managed by the management device 102. For example, the network device 104 may comprise a personal computer (PC), which may be operated in a network managed by the management device 102. Additionally, the network device 104 may also comprise a dedicated entity, for example the management service 110, to enable participating in management operations.

The management service 110 may comprise logic, circuitry, and/or code that may enable performing management operation based on one or more management standards. For example, the management service 110 may enable participating in control and/or management operations, based on WS-Management and/or ASF protocols. The management service 110 may comprise a logical and/or software entity that may be integrated within an OS running in the network device 104. The management service 110 may also comprise a logical and/or software entity that may be integrated within a general network controller (NIC) which may be running in the network device 104. Additionally, the management service 110 may comprise a logical and/or software entity that may be integrated within a network controlled running within a dedicated management sub-system within the network device 104.

The management connection 106 may comprise a network interface and/or a link that may enable management interactions and/or traffic between management devices, for example the management device 102, and network devices such as the network device 104. The management connection 106 may, for example, comprise a network connection via the Ethernet (IEEE 802.3) protocol, for example, which may enable the management device 102 and/or the network device 104 to exchange management related messaging, via Ethernet packets for example.

In operation, one or more standards-based management protocols may be utilized, via the management connection 106, to enable performing management operations between the management device 102 and the network device 104, wherein management based messaging may be carried via network traffic. For example, the remote management agent 108 and/or the management service 110 may enable utilizing WS-management and/or ASF messaging, via the management connection 106, to enable management operations between the management device 102 and the network device 104.

The management connection 106 may comprise use of one or more management protocols specified and/or published by standards entities such as the Distributed Management Task Force (DMTF). The management connection 106 may, for example, enable utilizing DMTF-based Alert Standard Format (ASF) protocol messaging and/or WS-Management (WS-Man) protocol messaging. The Alert Standard Format (ASF) protocol may be utilized in first generation management systems. The ASF protocol may comprise utilization of User Datagram Protocol (UDP) stack to enable communication between management devices and network devices. Devices comprising ASF functionality and/or interface may perform management operations via ASF messaging transmitted and/or received through network traffic, via the UDP. For example, in instances where the network device 104 may be ASF capable, the management device 102 may utilize ASF based messaging, via UDP, to perform management of the network device 104.

More recently, WS-Management (WS-MAN) was proposed and developed as the next generation management protocol. The WS-Management is a specification based on Web Services, which may typically be based on Transmission Control Protocol (TCP), and may utilize SOAP (XML based messaging) and HTTP(S) as a SOAP transport for communications. SOAP over HTTP(S) may require HTTP/TLS/TCP stack implementation, which may ensure improved security, reliability, and OS-independence. Devices that may comprise Intelligent Platform Management Interface (IPMI) may perform management operations via WS-Management messaging transmitted and/or received through network traffic, via the TCP protocol. For example, in instances where the network device 104 may comprise IPMI, the management device 102 may utilize WS-Management based messaging, via the TCP protocol, to perform management of the network device 104.

Consequently, UDP and/or TCP based communication, via the management connection 106, may be transmitted and/or received between the management device 102 and the network device 104 during ASF and/or WS-Management based operations via, for example, Ethernet packets.

The management device 102 and/or the network device 104 may utilize network cards (NIC) to enable sending and/or receiving network traffic via the management connection 106. The network controller that may be utilized in the management device 102 and/or the network device 104 may process network traffic that may comprise ASF and/or WS-Management based messaging, which may be transmitted and/or received via TCP and/or UDP based packets, respectively. Additionally, the management device 102 and/or the network device 104 may also comprise dedicated subsystem to enable processing management data and/or messaging.

In an embodiment of the invention, at least a portion of processing of network traffic that may comprise WS-Management messaging may be performed externally to network controllers in the management device 102 and/or the network device 104. External processing of WS-Management messaging may enable utilizing dedicated processors, which may be loaded and/or updated with the WS-Management based functionality, for example, and may also enable compatibility with various types of available network controllers. Consequently, filters may be setup in the network controllers, via the dedicated management processing entities for example, to determine network packets that may carry management traffic; and said packets may then be acted upon according, for example getting routed to the dedicated management processing entities.

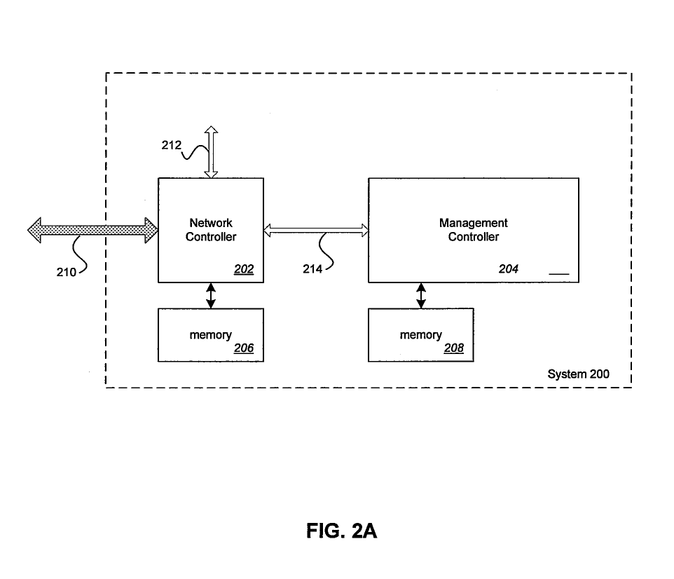

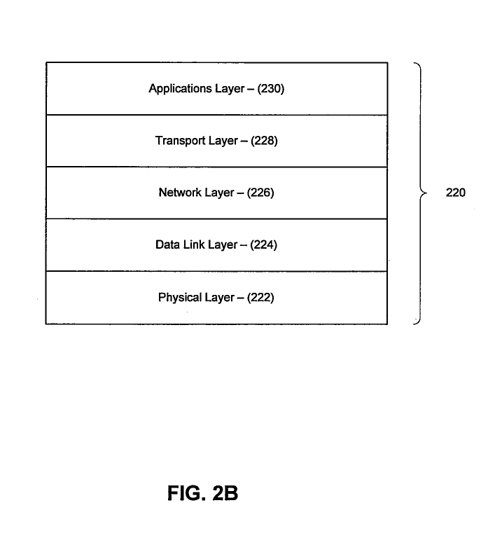

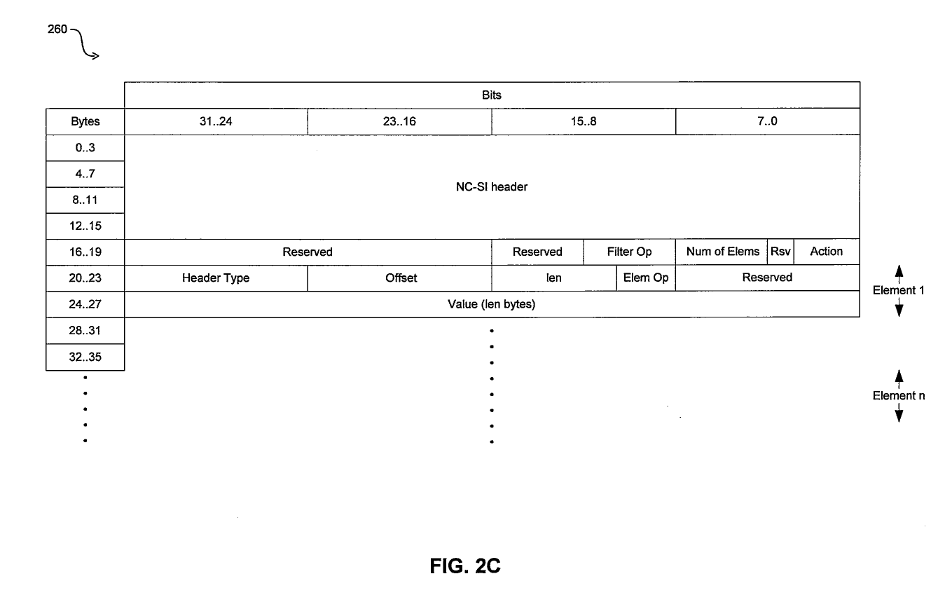

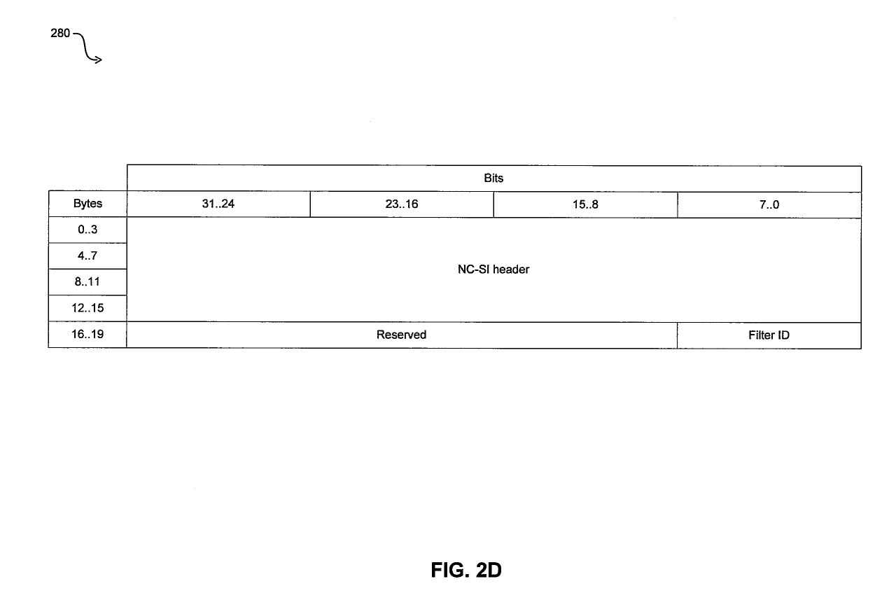

FIG. 2A is a block diagram that illustrates an exemplary system that comprises a network controller and a management controller, which may be utilized to enable packet filtering of management traffic, in accordance with an embodiment of the invention. Referring to FIG. 2A, there is shown a system 200, a network controller 202, a management controller 204, a network memory 206, a management memory 208, a network traffic 210, a host traffic 212, and a management traffic 214.

The system 200 may comprise the network controller 202, the management controller 204, the network memory 206, the management memory 208, and may also comprise suitable logic, circuitry, and/or code that may enable reception, transmission, and/or processing of network traffic; and/or participating in management operations based on one or more management standards. For example, system 200 may be integrated in the management device 102 and/or the network device 104 to enable performing WS-Management and/or ASF management operations, substantially as described in FIG. 1A.

The network controller 202 may comprise suitable logic, circuitry, and/or code that may enable handling of network traffic, for example the network traffic 210, which may be received and/or transmitted by the system 200. The network memory 206 may comprise suitable logic, circuitry, and/or code that may enable storage and/or retrieval of data and/or code, which may be utilized by the network controller 202, for example. In this regard, the network memory 206 may comprise different memory technologies, including, for example, non-volatile random access memory (NVRAM) and/or Flash memory.

The management controller 204 may comprise suitable logic, circuitry, and/or code that may enable processing of management traffic, received and/or transmitted via the network controller 202 for example, which may be based on a specific management standard including, for example, WS-Management. The management controller 204 may also be enabled to interact with other components in the system 200 to facilitate reception, transmission, and/or processing of management messaging. For example, the management controller 204 may be enabled to create packet filters, via the network controller 202 to determine and/or extract network packets that may carry management traffic. The management memory 208 may comprise suitable logic, circuitry, and/or code that may enable storage and/or retrieval of data and/or code, which may be utilized by the management controller 204, for example. In this regard, the management memory 208 may comprise different memory technologies, including, for example, non-volatile random access memory (NVRAM) and/or Flash memory.

The network traffic 210 may comprise received and/or transmitted packets communicated via a network connection, which may comprise, for example, an Ethernet (IEEE 802.3) connection. The traffic 210 may comprise the host traffic 212 and/or management traffic 214. The host traffic 212 may comprise data transmitted and/or received by subsystems and/or application in the system 200. For example, the host traffic 212 may comprise data transmitted by web browsing applications that may be running in the network device 104. The management traffic 214 may comprise data and/or messages transmitted and/or received in the system 200 during management operations. For example, the management traffic 214 may comprise WS-Management based messaging communicated via the system 200 to enable performing WS-Management services.

In operations, the network controller 202 may enable processing network traffic 210. The network controller 202 may utilize the network memory 206 to retrieve and/or store data and/or code that may be utilized during processing of network traffic 210. The management controller 204 may be utilized, in the system 200, to enable external processing of management traffic 214 transmitted and/or received via the network controller 202 in the system 200, and carried via the network traffic 210. The management controller 204 may utilize the management memory 208 to retrieve and/or store data and/or code that may be utilized during processing of management traffic 214.

In an exemplary embodiment of the invention, during downlink communications, where the network controller 202 may be utilized to enable processing of network traffic 210 received in the system 200, the network controller 202 may determine whether received traffic is host traffic 212 and/or management traffic 214. In the downlink direction, the host traffic 212 may be forwarded from the network controller 202 to appropriate subsystems, devices, and/or application in the system 200. In the downlink direction, the management traffic 214 may be forwarded to the management controller 204 to enable processing of received management data and/or messages in the system 200, via the management controller 204. Determining whether packets received via the network traffic 210 may comprise host traffic 212 and/or management traffic 214 may be performed via packet filters, which may be setup in the network controller 202, via the management controller 204 for example. The management controller 204 may utilize commands to set packet filters in the network controller 202. The packet filters may enable determining whether received packets may correspond to management messaging by keying on match criteria within packets received via the network traffic 210 for example. Commands utilized to setup the packet filters may comprise, for example, information pertaining to matching operations, wherein matching location(s) within network packets, matching values, and/or matching conditions, for example, may be specified. Additional commands may also be utilized to enable modifying and/or deleting existing packet filters. Setting up packet filters maybe preconfigured within system 202; and/or packet filters may be setup dynamically based on, for example, a determination of type of management traffic expected and/or generated.

During uplink operations, in instances where the network controller 202 may be utilized to enable processing network traffic 202 transmitted from the system 200, the network controller 202 may enable forwarding uplink host traffic 212 and/or uplink management traffic 214. In the uplink direction, the host traffic 212 may be received by the network controller 202, from appropriate subsystems, devices, and/or application in the system 200, and may be processed to enable transmission via a network connection, for example an Ethernet (IEEE 802.3) connection, that may be available in the system 200. In the uplink direction, the management traffic 214 may be received by the network controller 202, from the management controller 204, and may then be processed to enable transmission by the network controller 202 via a network connection, for example an Ethernet (IEEE 802.3) connection.

In an embodiment of the invention, a portion of management traffic received and/or transmitted via the network traffic 210 may be processed within the network controller 202, and/or external to both the network controller 202 and the management controller 204. For example, received and/or transmitted ASF based management messaging may be processed within the network controller 202. Accordingly, packet filters setup in the network controller 202 may be utilized to facilitate determination of management traffic that may not be processed in the management controller 204. Packets determined to carry management traffic may either be processed in the network controller 202, or may be routed to other components and/or subsystems in the system 200.

FIG. 2B is a block diagram illustrating an exemplary protocol stack diagram for management-based application data carried via network traffic, in accordance with an embodiment of the invention. Referring to FIG. 2B, there is shown a network stack 220 that may comprise a physical layer 222, a data link layer 224, a network layer 226, a transport layer 228, and an applications layer 230.

The network stack 220 may enable generating and/or processing of network packets that may carry management based data and/or messaging. For example, the network stack 220 may be utilized in the system 200 to enable generation and/or processing of Ethernet (802.3) packets that may be transmitted and/or received via the network traffic 210.

The physical layer 222 may enable facilitating physical transmission and/or reception of network traffic packets via physical mediums. For example, in a network stack that may be based on the Ethernet interface (IEEE 802.3), the physical layer 222 may correspond to the Ethernet physical layer component that may enable transmission and/or reception of Ethernet packets via Ethernet enabled physical connectors.

The data link 224 may enable functionality that may facilitate transmission and/or reception of data frames via the physical layer 222 based on data link protocols. For example, in a network stack that may be based on the Ethernet interface (IEEE 802.3), the data link layer 224 may be enabled performing MAC operations based on the Carrier Sense Multiple Access With Collision Detection (CSMA/CD) protocol. The data link layer 224 may comprise functionality that may enable generating and/or processing of data link frame headers to facilitate, for example, packing and/or extraction of network layer 226 data into/from Ethernet packets.

The network layer 226 may enable performing end-to-end transmission and/or reception of data based on a network protocol. For example, the network layer 226 may comprise the Internet Protocol (IP), based on the IP version 4 (IPv4) and/or IP version 6 (IPv6), which may be utilized to enable performing such operations as source/destination addressing, routing, and/or reliability related information setting. The network layer 226 may comprise functionality that may enable generating and/or processing of network frame headers, for example IP headers, to facilitate packing and/or extraction of transport layer 228 data into/from network layer 226 frames.

The transport layer 228 may enable performing transport related functionality based on a transport protocol. For example, the transport layer 228 may comprise TCP functionality in a TCP based communication, for example WS-Management based messaging; and/or may comprise UDP functionality in a UDP based communication, for example ASF based messaging. The transport layer 228 may comprise functionality that may enable generating and/or processing of transport frame headers, for example TCP and/or UDP headers, to facilitate packing and/or extraction of application layer 230 data into/from transport layer 228 frames.

The application layer 230 may enable performing, for example, peer-to-peer messaging based on one or more specific applications. For example, the application layer 230 may comprise management based communication between WS-Management enabled devices, for example the management device 102 and the network device 104.

FIG. 2C is a block diagram illustrating an exemplary structure of a command that may be utilized to set packet filters in a network controller, in accordance with an embodiment of the invention. Referring to FIG. 2C, there is shown a format of a Set Packet Filter command, which may be utilized, to enable setting up packet filters.

The Set Packet Filter command may comprise an NC-SI header, which may be utilized to enable messaging between the network controller 202 and the management controller 204. The NC-SI header may comprise, for example, 16 byes; corresponding to various information that may enable, for example, determining the command and/or response sent and/or received by the management controller 204. For example, the NC-SI may comprise information that may enable identifying a message as a Set Packet Filter command. The Set Packet Filter command may also comprise one or more bits allocated for a filter op-code field, one or more bits allocated for a number of elements field, one or more bits allocated for an action field, and one or more bits allocated for a reserved field. The Set Packet Filter command may also comprise one or more elements, element-1 . . . element-n, which may be utilized to specify information that may enable setting up packet filters. Element-1 may, for example, comprise one or more bits allocated for a header type field, one or more bits allocated for an offset field, one or more bits allocated for a length field, one or more bits allocated for an element op-code field, one or more bits allocated for a reserved field, and one or more bits allocated for a value field.

In operation, the Set Packet Filter command may be utilized in a system, for example the system 200, to enable setting up packets filters, which may enable determining network packets that may be carrying management traffic. The Set Packet Filter command may enable a network controller, for example the network controller 202, to perform packet filtering. The Set Packet Filter command may be described as a series of bytes that may be communicated over an internal network or physical medium inside the system. The command may be expanded to have multiple packet filters communicated in a single command, for example, as a command to set a packet filter. The Set Packet Filter command may be utilized by a management controller, for example the management controller 204, to communicate a packet filter to a network controller 202. The Set Packet Filter command may be executed in request/response form, for example. The Set Packet Filter command may utilize an element construct and may combine one or more elements to define a packet filter. The number of elements field may comprise a plurality of bits, for example 4 bits, to describe the number of elements utilized for the packet filter.

The action field may describe the action that needs to be performed after detecting a packet filter match. For example, in instances where the action field may be 000b, the packet may be forwarded to the management controller 204, via the management traffic 214. In instances where the action field is 001b, for example, the packet may be forwarded to the management controller 204 and the host, via the management traffic 214 and the host traffic 212, respectively, for example. In instances where the action field is 010b, for example, the packet may be filtered but may not be forwarded to the management controller 204. In instances where the action field is 011b, for example, the packet may only be forwarded to the host. If the action field is 100b-111b, the field may be reserved. The filter op code field may define the op code for combining the elements of the packet filter. For example, in instances where the filter op code field is 000b, a logical AND operation may be performed. In instances where the filter op-code field may be 001b-111b, for example, the field may be reserved. Where the filter op-code field indicates a logical AND operation, for example, the matching criteria for all element pertaining to a packet filter for a determining of ‘match.’ For example, a network packet may be utilized to carry management based messaging. The network packet may comprise a physical layer header corresponding to the physical layer 222, a data link header corresponding to the data link layer 224, a network layer header corresponding to the network layer 226, a transport layer header corresponding to the transport layer 228, and/or an application layer header corresponding to the application layer 228, substantially as described in FIG. 2B. The plurality of elements that may integrated into the Set Packet Filter command may be utilized to set matching criteria for each of the headers, and the filter op code field may be utilized to specify that matching criteria need be met in all the headers.

Within each element, the header type field may describe the starting location of the packet filter to determine a specific value. For example, in instances where the header type field is 000, an Ethernet header may be identified. In instances where the header type field may be 001b, for example, an IP header, for example, IPv4 or IPv6 may be identified. The header type field may represent the start of the base header for IPv6. In instances where the header type field may be 010b, for example, a TCP header may be determined. In instances where header type field is 011b, for example, a UDP header may be determined. The offset field may comprise a plurality of bits, for example, 6-bits or 8-bits. The offset field may describe the offset from the header to determine a specific value. The length field may describe the length of the value field that may be matched utilizing one of the following operations, for example, equal, not equal, greater than or lesser than operation. The element op-code field may represent the particular operation to be performed for an element. For example, in instances where the element op-code field may be 00, an equal operation may be indicated. In instances where the element op-code field may be 01b, for example, a not equal operation may be indicated. In instances where the element op-code field may be 10b, for example, a greater than operation may be indicated. In instances where the element op-code field may be 11b, for example, a less than operation may be indicated. The value field may be variable and may indicate the value that may be utilized for the match.

For example, the management controller 204 may utilize a Set Packet Filter command message to request the network controller 202 to setup a packet filter that may enable routing management based messaging and/or data. The management controller 204 may, for example, determine that the required filter may comprise 2 elements; consequently, in the Set Packet Filter command message sent to the network controller, the number of elements field may be set to ‘2’ indicating that the requested filter may comprise 2 elements. The action field may be set to 000b to indicate that matching packets may be forwarded to the management controller 204. The filter op-code field may be set to 0000b to indicate Logical AND. Element-1 may be utilized to enable matching based on Ethernet addressing information; consequently, in Element-1, the header type field may be set to 0×00 to indicate ‘Ethernet’, the offset field may be set to 0, the length field may be set to 6, the element op-code field may be set to 00 to indicate ‘equal’, and the value field may be set to the value of the MAC address of the management controller 204. Element-2 may be utilized to enable matching based on IP addressing information; consequently, in Element-2, the header type field may be set to 0×01 to indicate ‘IP’, the offset field may be set to 16, which may be the offset of the IP address field in Ethernet packets; the length field may be set to 4 where IPv4 may be utilized, the element op-code field may be set to 00 to indicate ‘equal’, and the value field may be set to the value of the IP address of the management controller 204.

When the network controller 202 receives Set Packet Filter command message from the management controller 204, the network controller 202 may process the command; and may set up one or more filters based on specified criteria. Alternatively, the network controller 202 may determine that no filters, as requested, may be setup. Once the network controller 202 completes processing the received Set Packet Filter command, the network controller 202 may send a Set Packet Filter Response message, which may comprise response code field that may indicate whether a packet filter was set successfully or whether processing of the received Set Packet Filter command failed; and may also comprise reason code field that may indicate reasons for failure to setup filters as requested when a failure is indicated. The Set Packet Filter Response message may also comprise a filter identifier, which may be utilized, via the management controller 204 for example, to enable subsequent modifications and/or deletions of the setup packet filters.

FIG. 2D is a block diagram illustrating an exemplary structure of a command that may be utilized to delete packet filters in a network controller, in accordance with an embodiment of the invention. Referring to FIG. 2D, there is shown a format of a Delete Packet Filter command, which may be utilized, to enable deleting setup packet filters.

The Delete Packet Filter command may comprise an NC-SI header, which may be utilized to enable messaging between the network controller 202 and the management controller 204. The NC-SI header may comprise, for example, 16 bytes; corresponding to various information that may enable, for example, determining the command and/or response sent and/or received by the management controller 204. For example, the NC-SI may comprise information that may enable identifying a message as a Delete Packet Filter command. The Delete Packet Filter command may also comprise one or more bits allocated for a reserved field, and one or more bits allocated for a filter identifier field.

The filter identifier field may comprise a value corresponding to a filter that may have previously been setup by the management controller 204, via a Set Packet Filter command for example. The filter identifier may be maintained in the management controller 204 based on value indicated in a Set Packet Filter Response message for example.

In operation, the Delete Packet Filter command may be utilized in a system, for example the system 200, to enable deleting packets filters, which may have been setup to enable determining and/or routing of network packets that may be carrying management traffic. For example, the management controller 204 may receive a Set Packet Filter Response message corresponding to a Set Packet Filter command that may have been sent by the management controller 204. Where the Set Packet Filter Response message may indicate successful setup of packet filters, the management controller 204 may store the value of the filter identifier field in the Set Packet Filter Response message, in the memory 208 for example. Consequently, once the management controller 202 may determine that the setup filters may need to be deleted, the management controller 204 may send a Delete Packet Filter command, and may utilize the stored filter identifier to set the value of the filter identifier field in the Delete Packet Filter command.

When the network controller 202 receives Delete Packet Filter command message from the management controller 204, the network controller 202 may process the command; and may delete filters corresponding to the filter identifier filed. Alternatively, the network controller 202 may determine that no filters correspond to the filter identifier filed specified in the received Delete Packet Filter command. Once the network controller 202 completes processing the received Delete Packet Filter command, the network controller 202 may send a Delete Packet Filter Response message. The Delete Packet Filter Response may comprise response code field that may indicate whether a packet filter was deleted successfully or whether processing of the received Delete Packet Filter command failed. The Delete Packet Filter Response may also comprise reason code field that may indicate reasons for failure to delete filters as requested when a failure is indicated.

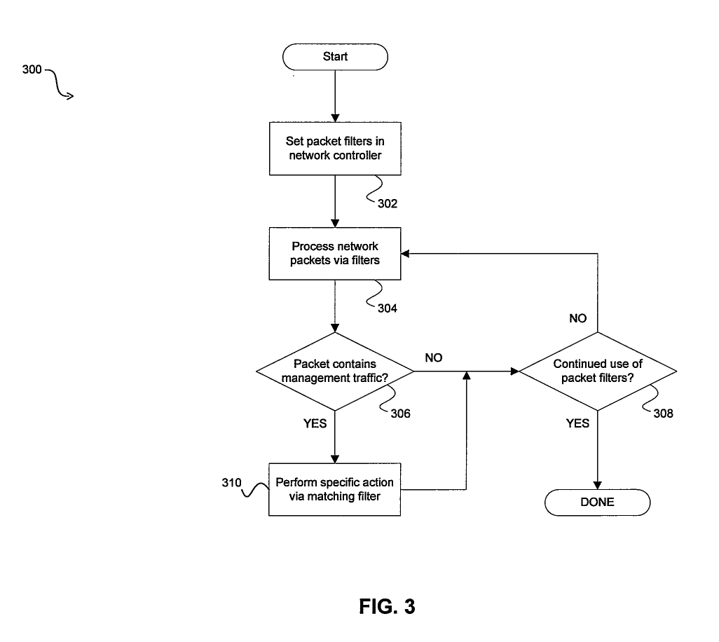

FIG. 3 is a flow diagram that illustrates exemplary messaging during packet filtering setup in a system, in accordance with an embodiment of the invention. Referring to FIG. 3, there is shown a flow chart 300 comprising a plurality of exemplary steps, which may enable utilizing of packet filters in network controllers during management communications in a system.

In step 302, packet filters may setup in a network controller. For example, packet filters may be setup in the network controller 202, via the management controller 204. The management controller 204 may utilize the Set Packet Filter command to specify, for example, matching criteria and/or action pertaining to packet filters that may be setup in the network controller 202; substantially as described in FIG. 2C. In step 304, received network packets may be processed via the packet filters. For example, packets filters setup via the Set Packet Filter command may be utilized, in the network controller 202, to process network packets received via the network traffic 210. In step 306, a determination whether received network packet comprise management traffic may be performed via packet filters. Set Packet Filter commands sent to the network controller 202, via the management controller 204, may specify match criteria that may be utilizing in determining whether received network packet may constitute a match. The match criteria may comprise determining type of header within network packet, offset, and/or match operator. Additionally, Set Packet Filter commands may enable specifying a plurality of elements that may enable performing one or more matching operations within different headers that may be integrated in received network packets; substantially as described in FIG. 2C. In instances where it may be determined that received network packet does not comprise management traffic, the plurality of exemplary steps may proceed to step 308.

In step 308, a determination whether continued use of existing packet filters may be performed. The management controller 204 may, for example, utilize filter specific commands to delete existing packet filters, for example the Delete Packet Filter commands, utilizing filter identifiers received in Set Packet Filter Responses sent via the network controller 202 upon a successful execution of a Set Packet Filter commands. Consequently, use of packet filtering may discontinue where all existing packet filters may have been deleted. In instances where it may be determined that use of packet filters may not be continued, the plurality of exemplary steps may terminate.

Returning to step 308, in instances where it may be determined that use of packet filters may be continued, for example where not all existing packet filters have been deleted, the plurality of exemplary steps may proceed back to step 304, wherein additionally received network packet may be processed.

Returning to step 306, in instances where it may be determined that received network packet may comprise management traffic, the plurality of exemplary steps may proceed to step 310. In step 310, specified actions to be taken on network packets that may constitute a ‘match’ within the packet filter may be performed. For example, the Set Packet Filter command may be utilized to indicate that network packet comprising a match within the specified matching criteria may be routed to management controller 204, forwarded to the host, and/or processed within the network controller 202. The plurality of exemplary steps may then proceed to step 308.

Various embodiments of the invention may comprise a method and system for a mechanism to communicate packet filtering information. In system 200, which may be integrated into the management device 102 and/or the network device 104 to enable participating in management operations; a portion of management traffic, carried via the network traffic 210, and received and/or transmitted via the network controller 202, may be processed externally to the network controller 202. Management based messaging transmitted and/or received via the system 200 may be carried via network packets, which may comprise the network stack 200, wherein management data may be encapsulated, and one or more headers may be added to enable transmission and/or reception via the network controller 202. Packet filters may be setup, in the network controller 202, to enable determining network packets that may carry the management traffic 214, which may be processed externally. The packet filters may be setup in the network controller 202 via the management controller 204. The management controller 204 may utilize Set Packet Filter command to setup packet filers in the network controller 202. The Set Packet Filter command may specify matching criteria, in the received network packets, and/or corresponding actions that may be performed in matching packets. The matching criteria may comprise specifying one or more header types, which may be integrated into the received network packets. The network controller 202 may communicate back to the management controller 204 filter identifiers that may be utilized, subsequently, to delete the packet filter.

Another embodiment of the invention may provide a machine-readable storage, having stored thereon, a computer program having at least one code section executable by a machine, thereby causing the machine to perform the steps as described herein for communicating packet filtering information.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for network management, the method comprising:
configuring one or more packet filters in a network controller based on information received from a management controller;
reporting information regarding said configuring of said one or more packet filters to said management controller; and
identifying via said configured one or more packet filters, received network packets comprising management traffic, so as to determine how to handle said identified received network packets.

2. The method according to claim 1, comprising receiving one or more commands from said management controller that enables said configuring of said one or more packet filters.

3. The method according to claim 2, wherein said one or more received commands enables setup, modification and/or deletion of said one or more packet filters.

4. The method according to claim 1, wherein said reported information enables said management agent to manage said configured one or more packet filters in said network controller.

5. The method according to claim 1, wherein said reported information comprises an identifier corresponding to each of said one or more packet filters.

6. The method according to claim 1, comprising filtering said received network packets via said one or more configured packet filters to enable said identification.

7. The method according to claim 6, wherein said filtering is based on matching criteria that comprise a matching location within said packets, a matching value, and/or a matching operation.

8. The method according to claim 1, comprising communicating at least a portion of said received network packets from said network controller to said management controller and/or one or more processors based on said identification.

9. The method according to claim 8, wherein said one or more processors comprises a host processor.

10. The method according to clam 1, comprising processing at least a portion of said received network packets by said network controller based on said identification.

11. The method according to claim 1, wherein said management traffic comprises Alert Standard Format (ASF) based messaging and/or WS-Management based messaging.

12. A system for network management, the system comprising:
one or more processors that enable configuring of one or more packet filters in a network controller based on information received from a management controller;
said one or more processors enable reporting of information regarding said configuring of said one or more packet filters to said management controller; and
said one or more processors enable identification of received network packets comprising management traffic, via said configured one or more packet filters, so as to determine how to handle said identified received network packets.

13. The system according to claim 12, wherein said one or more processors enable receiving of one or more commands from said management controller that enables said configuring of said one or more packet filters.

14. The system according to claim 13, wherein said one or more received commands enables setup, modification and/or deletion of said one or more packet filters.

15. The system according to claim 12, wherein said reported information enables said management agent to manage said configured one or more packet filters in said network controller.

16. The system according to claim 12, wherein said reported information comprises an identifier corresponding to each of said one or more packet filters.

17. The system according to claim 12, wherein said one or more processors enable filtering of said received network packets via said one or more configured packet filters to enable said identification.

18. The system according to claim 17, wherein said filtering is based on matching of criteria that comprise a matching location within said packets, a matching value, and/or a matching operation.

19. The system according to claim 12, wherein said one or more processors enable communication of at least a portion of said received network packets from said network controller to said management controller and/or one or more processors based on said identification.

20. The system according to claim 19, wherein said one or more processors comprises a host processor.

21. The system according to clam 12, wherein said one or more processors enable processing of at least a portion of said received network packets by said network controller based on said identification.

22. The system according to claim 12, wherein said management traffic comprises Alert Standard Format (ASF) based messaging and/or WS-Management based messaging.

23. A machine-readable storage having stored thereon, a computer program having at least one code section for network management, the at least one code section being executable by a machine for causing the machine to perform steps comprising:
configuring one or more packet filters in a network controller based on information received from a management controller;
reporting information regarding said configuring of said one or more packet filters to said management controller; and
identifying via said configured one or more packet filters, received network packets comprising management traffic, so as to determine how to handle said identified network packets.

24. The machine-readable storage according to claim 23, wherein said at least one code section comprises code for receiving one or more commands from said management controller that enables said configuring of said one or more packet filters.

25. The machine-readable storage according to claim 24, wherein said one or more received commands enables setup, modification and/or deletion of said one or more packet filters.

26. The machine-readable storage according to claim 23, wherein said reported information enables said management agent to manage said configured one or more packet filters in said network controller.

27. The machine-readable storage according to claim 23, wherein said reported information comprises an identifier corresponding to each of said one or more packet filters.

28. The machine-readable storage according to claim 23, wherein said at least one code section comprises code for filtering said received network packets via said one or more configured packet filters to enable said identification.

29. The machine-readable storage according to claim 28, wherein said filtering is based on matching criteria that comprise a matching location within said packets, a matching value, and/or a matching operation.

30. The machine-readable storage according to claim 23, wherein said at least one code section comprises code for communicating at least a portion of said received network packets from said network controller to said management controller and/or one or more processors based on said identification.

31. The machine-readable storage according to claim 30, wherein said one or more processors comprises a host processor.

32. The machine-readable storage according to clam 23, wherein said at least one code section comprises code for processing at least a portion of said received network packets by said network controller based on said identification.

33. The machine-readable storage according to claim 23, wherein said management traffic comprises Alert Standard Format (ASF) based messaging and/or WS-Management based messaging.
